(19) United States
(12) Patent Application Publication
(10) Pub. No.: US 2007/0124186 A1
(43) Pub. Date: May 31, 2007

(54) Method of managing project uncertainties using event chains

(76) Inventor: Lev Virine, Calgary (CA)

Correspondence Address: Lev Virine, 303, 6707, Elbow Drive S.W., Calgary, AB, T2V 0E5, CA

(21) Appl. No.: 11/272,350

(22) Filed: Nov. 14, 2005

(51) Int. Cl. G06F 9/46

(52) U.S. Cl. 705/8

(57) ABSTRACT

The method of managing project uncertainties using event chains is disclosed. The method includes the steps of: (a) identification of events which may occur during a course of an activity, determining their probability and impact, (b) identification of event chains; and (c) performing quantitative analysis to determine effect of events and event chains on a project schedule. Quantitative analysis may be performed using Monte Carlo simulations. Events and event chains may be identified using project historical data and based on analysis of actual project performance. Event chain diagrams may be used to visualize events and event chains. Identification of critical events or event chains may be performed using sensitivity analysis.

### RELATED APPLICATIONS

This application is related to provisional U.S. patent application Ser. No. US60/625,072, entitled METHOD OF MANAGING PROJECT UNCERTAINTIES USING EVENT CHAINS, filed Nov. 5, 2004.

### BACKGROUND OF THE INVENTION

1. Field of the Invention

This invention relates to methods for use in area of managing uncertainties in project management. More specifically, the invention provides methods for more effectively and efficiently performing time, scope, and cost management project for projects with risks and uncertainties.

2. Background of the Invention

Majority of project activities are affected by multiple risks and uncertainties. (See Klastorin, T., Project Management. Tools and Trade-Offs, New York, N.Y.: Wiley, 2004).

Project planning usually starts with the development of a deterministic Work Breakdown Structure. Work Breakdown Structure can be visualized using Gantt chart. Project managers can use the critical path method to identify the critical path (See Kerzner, H., 2003, Project Management: a System Approach to Planning, Scheduling, and Controlling, NJ: John Wiley & Sons).

Uncertainties, related to the project schedule, can be expressed using different quantitative analysis methodologies. One of the most common and easy to implement methodologies is the analysis of different project scenarios associated with a whole or a portion of the project schedule. Different project scenarios will have different durations, finish time, and cost. Decision tree analysis can be performed to select the optimum course of action. The project manager can perform a ‘what-if’ analysis to model the project schedule under different conditions.

The PERT model (Program Evaluation and Review Technique) was developed to address uncertainty in the estimation of project parameters. According to classic PERT, expected task duration is calculated as the weighted average of the most optimistic, the most pessimistic, and the most likely time estimates. The main shortfall of classic PERT is that it gives accurate results only if there is a single dominant path through a precedence network (See Cho J. G. and Yum B. J., “An Uncertainty Importance Measure of Activities in PERT Networks”. International Journal of Production Research, 12, 1964, 460-470).

Alternatively, to address these shortcomings, Monte Carlo simulations can be used to model uncertainties. Monte Carlo simulations are a process that repeatedly sets values for each random variable (duration, cost, start and finish time, etc.) by sampling from each variable's statistical distribution. Monte Carlo simulations have been proven to be an effective methodology for the analysis of project schedules with uncertainties (See Hulett D. T., “Schedule Risk Simplified”, PM Network, July, 1996, 23-30). This method allows introduction of probabilistic and conditional branching, sensitivity analysis, and identification of crucial tasks, criticality indices, probabilistic calendars, and additional types of analysis.

However, Monte Carlo simulation also has a number of shortcomings. Uncertainties in project parameters, such as duration, cost, finish time, etc., are related to a lack of knowledge about the project or particular activity. Analysis of such uncertainties can be performed using accurate historical data and by providing actual project performance measurements, which not always available. In addition, the methodology does not take into account management responses to delayed or over budget projects (See Williams, T. W., Modeling Complex Projects. Wiley, New York, 2002).

The Bayesian approach allows probabilities to be assigned to random events, but also allows the assignment of probabilities to any other kind of statement. When comparing two sets of data and using some information Bayesian method would suggest that one set was more probable than the other.

The proper modeling of uncertainties in project schedules using all these aforementioned methods is a very complex process. In addition to defining the uncertainties related to the duration and cost of activities, project calendars, resource allocation, etc., the manager must identify different project scenarios and the probabilistic relationships between them, identify mitigation efforts, and analyze complex ‘what-if’ relationships. In some situations with a large number of activities, this type of modeling may not be feasible.

### SUMMARY OF THE INVENTION

In view of the above problems, an object of the present invention is to provide methods for managing project uncertainties while eliminating or minimizing the impact of the problems and limitations described.

The method includes the steps of: (a) identification of events which may occur during a course of an activity, determining their probability and impact, (b) identification of event chains; and (c) performing quantitative analysis to determine effect of events and event chains on a project schedule. Some embodiments of the invention may include the additional step of identification of critical events or event chains. Identification of critical events or event chains may be performed using sensitivity analysis. Some embodiments of the invention may include the additional step of visualization of events and event chains using event chain diagram. In some embodiments of the invention, step a) identification of events which may occur during a course of an activity, determining their probability and impact may be performed by calculation of probabilistic moment of event occurrence. In some embodiments of the invention, step a) identification of events which may occur during a course of an activity, determining their probability and impact may be performed based on analysis of historical project data. The analysis of historical project data may include the step of relevance analysis of the historical project data. The analysis of the historical project data may be performed using Bayesian approach. In some embodiments of the invention, step a) identification of events which may occur during a course of an activity, determining their probability and impact may be performed of based on analysis of actual project performance. The analysis of actual project performance may be performed using Bayesian approach. In some embodiments of the invention, step b) identification of event chains may include identification and analysis of repeated activities.

In some embodiments of the invention, step c) performing quantitative analysis to determine effect of events and events chains on a project schedule may be performed using Monte Carlo simulations. In some embodiments of the invention, step a) identification of events which may occur during a course of an activity, determining their probability and impact may include identification of mitigation schedule. Mitigation schedule may include the step of identification of entry and exit points. In some embodiments of the invention, step a) identification of events which may occur during a course of an activity, determining their probability and impact may include identification of events causing reallocation of resources. In some embodiments of the invention, step b) identification of event chains further may include identification of delay between the events within the chain.

### BRIEF DESCRIPTION OF THE DRAWINGS

FIG. 1 depicts an activity and a probabilistic event, which transforms the activity from one state to another.

FIG. 2 depicts a group of related activities and an event chain.

FIG. 3 depicts a hierarchical table of event with associated probability and impact.

FIG. 4 depicts a tornado diagram where critical events or event chains are shown on the top.

FIG. 5 depicts the original and forecasted duration of the activity

FIG. 6 depicts an event chain diagram.

FIG. 7 depicts repeated activities.

FIG. 8 depicts mitigation schedule with entry and exit points.

### DETAILED DESCRIPTION OF THE INVENTION

In the following detailed description of the preferred embodiments and other embodiments of the invention, reference is made to the accompanying drawings. It is to be understood that those of skill in the art will readily see other embodiments and changes may be made without departing from the scope of the invention.

The method of modeling project uncertainties using event chain is applied for modeling uncertainties for different projects particularly for project time, scope, and cost management. The method is based on existing analytical techniques including Monte Carlo simulation and Bayesian approach. The method of modeling project uncertainties is applied to the analysis of the project schedule, which comprises multiple related activities.

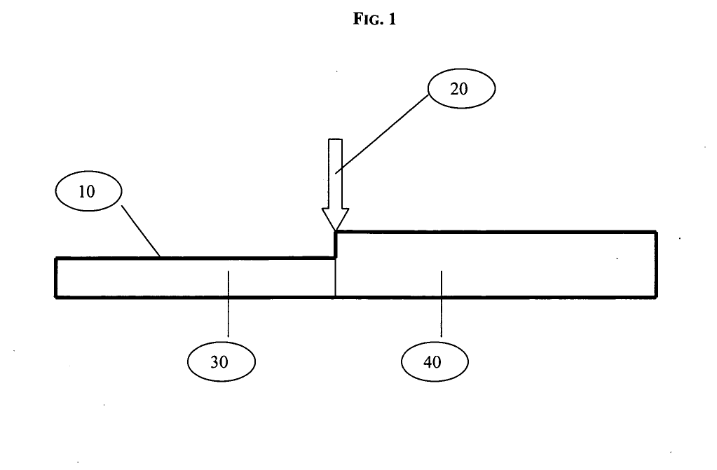

A method of managing project uncertainties using event chains includes the step of identification of events which may occur during a course of an activity, determining their probability and impact. FIG. 1 illustrates an activity and a probabilistic event. Activity 10 is affected by external event 20, which transform an activity from one state 30 to another state 40. Events have a number of properties. Among them are probability of occurrence; type (for example, cancel task, increase/reduce duration/cost, move resource to another start, change probability of other event, start activity, execute mitigation plan); and impact (for example, increase of duration by 10%). The moment, when an event occurs, in most cases is probabilistic and can be defined using statistical distribution, such as triangular, normal, lognormal, and others. The event impact depends on when an event occurs, as the moment of event affects, for example, whether an activity will be restarted or cancelled. Probabilistic moment of event occurrence is important for adjusting the duration or cost of an activity due to actual performance. States of activity can serve as a precondition for other events: some events may or may not occur or if the activity is in certain state.

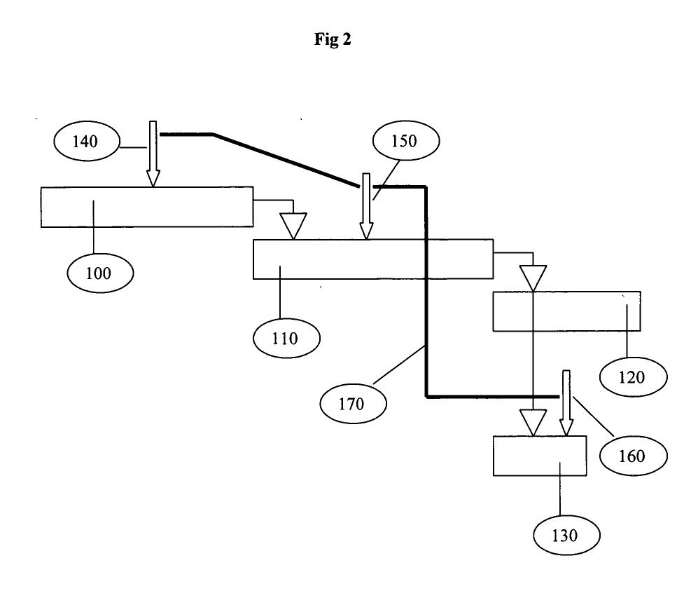

The next step is identification of event chains. FIG. 2 depicts a group of related activities 100, 110, 120, and 130 and an event chain. Activity 100 is affected by the event 140, Activity 110 is affected by the event 150, and activity 130 is affected by the event 160. Event 140 triggers event 150, and event 150 triggers event 160. It generates the chain of events 170. Event chains can be defined in several different ways. For example, a single event type can be defined as “Change probability of the particular event”. In this case, one event can trigger another event. Another way to define event chains is to use an event “Start another activity” or “Execute Mitigation Plan”. Event chains are identified in the same manner (names) as single events. Names are important for further sensitivity analysis of the chains.

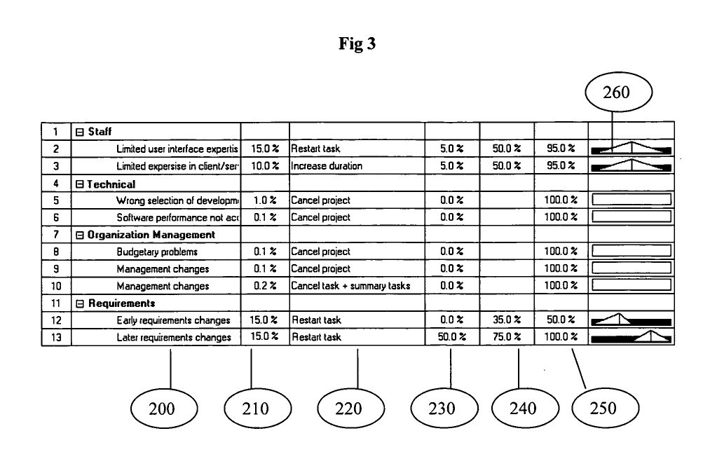

Events and events chains can be defined as event breakdown structure. FIG. 3 depicts a hierarchical table of event with associated probability and impact. Event breakdown structure includes summary events and sub-events. Events properties defined using event breakdown structure, include event name 200, probability of event occurrence 210, event impact 220, and probabilistic moment of event occurrence defined by the statistical distribution. For example, probabilistic moment of event occurrence can be defined using triangular statistical distribution. Parameters of the triangular distribution are low 230, most likely 240 and high 250 estimates of the moment of event occurrence. Statistical distribution can be depicted using chart 260 associated with the activity.

Once events and event chains are defined, quantitative analysis using Monte Carlo simulation can be performed to quantify the cumulative impact of the events. Probabilities and impacts of events are using as an input data for Monte Carlo simulation of the project schedule. In most projects, it is necessary to supplement the information regarding the uncertainties expressed as an event with distributions related to duration, start time, cost, and other parameters, as performed in classic Monte Carlo simulations. If the original (baseline) project schedule is defined as a “best case scenario”, continuous distributions skewed towards the beginning of the range may be used to represent small “fluctuations” in task parameters. Examples of these distributions can be Lognormal, Gumbel, Rayleigh, and Beta.

The single events or the event chains that have the most potential to affect the projects are the “critical events” or “critical chains of events.” By identifying critical events or critical chains of events, it is possible mitigate their negative effects. Analyzing the statistical correlation between main the project parameters, such as project duration or cost, and the event chains, can identify these critical chains of events. Critical chains of events based on cost and duration may differ. The correlation coefficient is calculated based on the cumulative impact of the event chain on activity duration or cost.

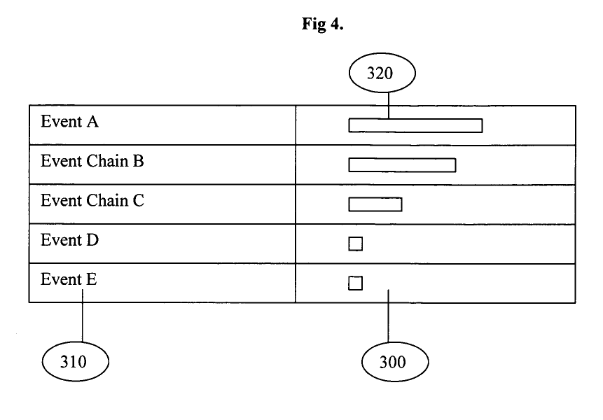

FIG. 4 depicts a tornado diagram where critical events or event chains are shown on the top. Each bar 300 is a graphic representation of the correlation coefficient between cumulative impact of the event 310 on activity's duration or cost and project duration or cost. Event 320 is a critical event.

Identification of critical events or chains of events is useful for reality checks. Usually, project managers intuitively know which event can have the most affect on the project schedule. Using tornado diagrams with critical events and event chains, they can verify if information about probabilities and impacts is defined and entered correctly

In many projects, it is hard to determine which historical data should be used as an analog for future analysis. For example, in many research and development projects, new projects may significantly differ from the previous projects. To improve the accuracy of estimates based on event occurrence data, the selection of analogs for the historical data should be done through an analysis using a Bayesian approach. Many events can be similar for different projects. For example, the event “Budgetary Risks” may have already occurred in a different project within an organization. As a result, historical information about events can be more comprehensive than information about the duration and cost of activities as many research and development projects have unique activities.

The selection of an event with its respective probabilities and impact from the historical data is based on an analysis of evidence regarding how relevant the event is to the current activity or project. Relevance analysis is performed using the different criteria. If an event is a full or partial match according to the selected criteria, it will contribute to the overall evidence that this event is relevant to the current activity. The selection criteria can include: events and event chains that belong to similar projects (similar cost, duration, or objectives), managed by the same project manager, and performed by the same organization; events and event chains that belong to similar tasks or group of activities (similar name, duration, and cost); events and event chains that occur during work performed by similar resources; events and event chains which have similar names, probabilities, and impacts.

Sometimes descriptions of current and previous projects, tasks, resources, and risks can differ slightly. Therefore, linguistic analysis can be applied for relevance analysis related to various descriptions. Sets of criteria and business rules for the relevance analysis are adjustable for different industries, organizations, and projects.

If the historical data has been properly collected, it may contain information about how particular events affected a previous project. This data can be used to calculate the probability and impact of the risk in the current project.

In addition to getting evidence of relevance for events from historical data, project managers may define a relevance coefficient or belief that the event is relevant to the current activity. For example, the event chain “Problem with supplier” has a 50% relevance according to the historical data. In addition, project managers may define that it has an additional 90% relevance based on own understanding of the event. In this case, both numbers will be used for calculating the probabilities and impact of events using the Bayesian approach.

Monitoring the activity's progress ensures that updated information is used to perform the analysis. During the course of the project, the probability and time of the events can be recalculated based on actual data. For example, probability of risks related to new technology, can be automatically reassessed and possibly significantly reduced on each subsequent phase of the project based on actual project data. Quantitative analysis can be performed again and a new project schedule and cost will be generated.

The main issue with performance tracking is forecasting an activity's duration and cost if an activity is partially completed and certain events are assigned to the activity. The simple heuristic approach to this problem is to analyze the moment of event occurrence, which is defined as one of the event parameters. If the moment of risk is earlier than the date when actual measurement is performed, this event will not affect the activity.

This main concern with this approach is whether it takes into consideration risks that have already occurred before the measurement. The solution can be found by performing an analysis of the historical data that is augmented with actual tracking data using a Bayesian approach where the plausibility of a given statement is updated in light of new evidence.

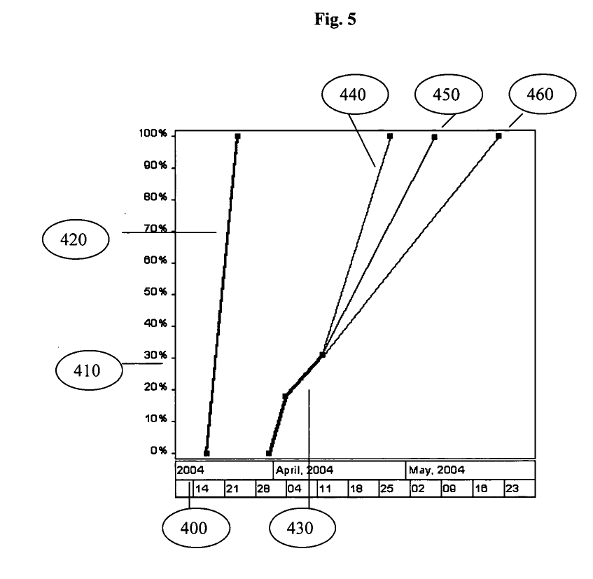

FIG. 5 depicts the original, actual, and forecasted duration of the partially completed activity. Similar diagram can be generated for the cost of the activities. Horizontal axis represents the project timeline 400. Vertical axis represents percent of activity completed 410. Original activity 420 (before performing Monte Carlo simulations) is presented together with actual performance of the activity 430, as well as optimistic 440, most likely 450, and pessimistic 460 estimates of the future activity performance.

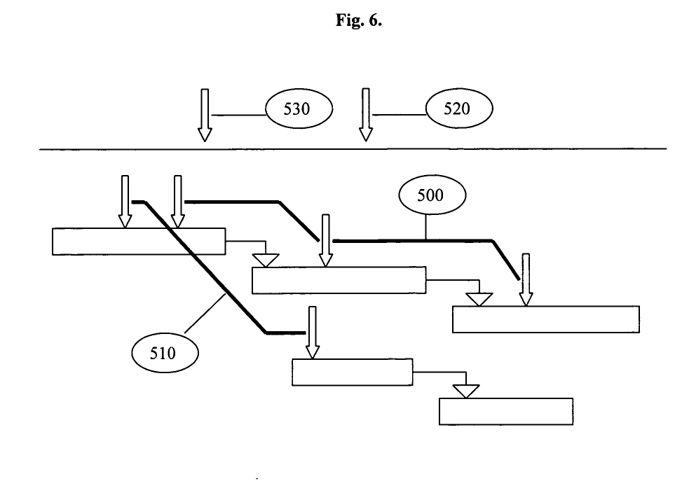

Event Chain Diagrams are visualizations that show the relationships between events and activities and how the events affect each other. The simplest way to represent these chains is to depict them as arrows associated with certain activities or time intervals on the Gantt chart. Different events and event chains can be displayed using different colors or line types. Events can be global (for all activities in the project) and local (for a particular activity). By using Event Chain Diagrams to visualize events and event chains, the modeling and analysis of risks and uncertainties can be significantly simplified. FIG. 6 depicts an event chain diagram. Activities are affected by event chains 500 and 510, as well as global single events 520 and 530.

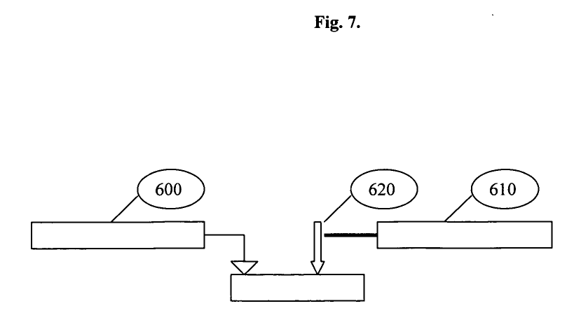

Sometimes events can cause the start of an activity that has already been completed. This is a very common scenario for real life projects; sometimes a previous activity must be repeated based on the results of a succeeding activity. The original project schedule does not need to be updated, as all that is required is to define the event and assign it to an activity that points to the previous activity. In addition, a limit to the number of times an activity can be repeated needs to be defined. FIG. 7 depicts repeated activities. Activity 600 may be repeated 610 if event 620 occurs.

If event or event chain occurs during the course of a project, it may require some mitigation effort. In some cases, mitigation plans can be generated. Mitigation plans are an activity or group of activities (small schedule) that augment the project schedule if a certain event occurs. Mitigation plans can be defined as a part of original project schedule and only executed under certain conditions. However, in these cases, the project schedule may become very convoluted due to multiple conditional branches, which significantly complicates the analysis. The solution is to assign the mitigation plan to an event or event chain. These small schedules will be triggered when an event chain occurs. The same mitigation plan can be used for different events. Each mitigation plan will have entry and exit points. As a result, the work breakdown structures of the original project schedule and the project schedule with simulation results (after performing Monte Carlo simulations) will be different.

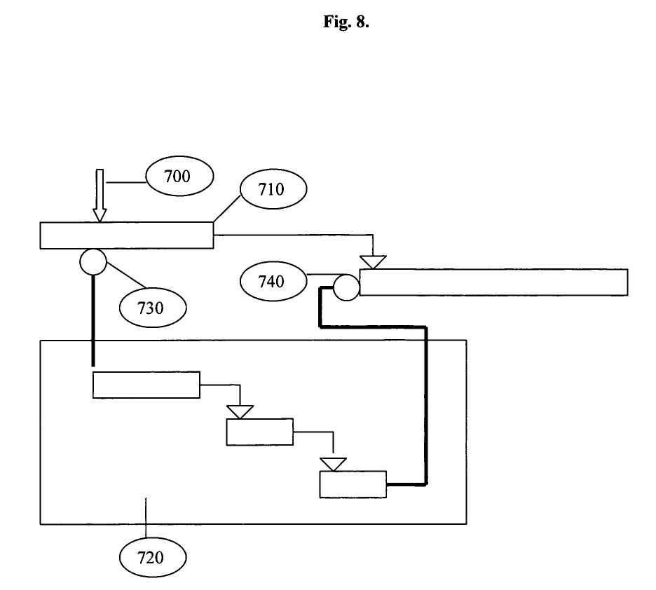

FIG. 8 depicts mitigation schedule with entry and exit points. Event 700 associated with the activity 710 triggers execution of the mitigation plan 720. The mitigation plan includes entry point 730 and exit point 740.

One potential event is the reassignment of a resource from one activity to another, which can occur under certain conditions. For example, if an activity requires more resources to complete it within a fixed period, this will trigger an event to reallocate the resource from another activity. Reallocation of resources can also occur when activity duration reaches a certain deadline or the cost exceeds a certain value. Events can be used to model different situations with resources, e.g. temporary leave, illness, vacations, etc. In some cases this can create an event chain: due to an illness, a resource from another activity would be borrowed to accomplish a specific task.

Events can cause other events to occur either immediately or with a delay. The delay is a property of the event. The delay can be deterministic, but in most cases, it is probabilistic. If we know the time of the original event and the delay, it is possible to determine when the new event can happen and in some cases, the activity that will be associated with it.

The basic analysis workflow using Event Chain Methodology is comprised of the following steps:
a. define a detailed project schedule with resources and costs assigned to the activities;
b. define a detailed event breakdown structure with events and event chains and assign event to the activities; the probability of each event can be taken from historical data; if necessary, an analysis of historical data using the Bayesian approach can be performed to determine the relevance of the historical data;
c. define the activities associated with mitigation efforts and then assign costs and resources to them;
d. perform a quantitative risk analysis using Monte Carlo Simulations; identify the chance that the project or each phase of the project will be completed on time, within a budget, and as a result understand contingency and reserves;
e. analyze the results of the quantitative analysis: perform a sensitivity analysis and identify the crucial tasks and critical events;
f. perform reality checks: compare the results of analysis with outside independent expert reviews and historical experience;
g. monitor the course of the project on a regular basis, perform repeated quantitative risk analysis, reassess the risks including the probability of risk occurrence based on actual data, and identify new project costs and duration.

Although the foregoing is provided for purposes of illustrating, explaining and describing of the invention in particular detail, modifications and adaptations to the described methods will be apparent to those skilled in the art and may be made without departing from the scope or spirit of the invention.

What is claimed is:

1. A method of managing project uncertainties using event chains, comprising the steps of:
a) identification of events which may occur during a course of an activity and determining their probability and impact;
b) identification of event chains; and
c) performing quantitative analysis to determine effect of events and event chains on a project schedule.

2. The method of claim 1 wherein the step c) performing quantitative analysis to determine effect of events and events chains on a project schedule is performed using Monte Carlo simulations.

3. The method of claim 1 wherein the step a) identification of events which may occur during a course of an activity, determining their probability and impact is performed by calculation of probabilistic moment of event occurrence.

4. The method of claim 1 further comprises the step of identification of critical events or event chains.

5. The method of claim 4 wherein the identification of critical events or event chains is performed using sensitivity analysis.

6. The method of claim 1 wherein the step a) identification of events that may occur during a course of an activity and determining their probability and impact is performed based on analysis of historical project data.

7. The method of claim 6 wherein the analysis of historical project data further includes the step of relevance analysis of the historical project data.

8. The method of claim 7 wherein the relevance analysis of the historical project data is performed using Bayesian approach.

9. The method of claim 1 wherein the step a) identification of events which may occur during a course of an activity, determining their probability and impact is performed based on analysis of actual project performance.

10. The method of claim 9 wherein the analysis of actual project performance is performed using Bayesian approach.

11. The method of claim 1 further includes the step of visualization of events and event chains using event chain diagram.

12. The method of claim 1 wherein the step b) identification of event chains includes identification and analysis of repeated activities.

13. The method of claim 1 wherein the step a) identification of events that may occur during a course of an activity and determining their probability and impact, includes identification of mitigation schedule.

14. The method of claim 13 wherein identification of mitigation schedule further includes the step of identification of entry and exit points.

15. The method of claim 1 wherein the step b) identification of event chains further includes the identification of delay between the events within the chain

16. The method of claim 1 wherein the step a) identification of events which may occur during a course of an activity, determining their probability and impact includes identification of events causing reallocation of resources.
